(19) United States
(12) Patent Application Publication
(10) Pub. No.: US 2023/0061104 A1
(43) Pub. Date: Mar. 2, 2023

(54) MOUSETRAP

(71) Applicant: HONGQIN LIU, SHENZHEN CITY (CN)

(72) Inventor: HONGQIN LIU, SHENZHEN CITY (CN)

(21) Appl. No.: 17/459,693

(22) Filed: Aug. 27, 2021

(51) Int. Cl. A01M 23/38

(52) U.S. Cl. CPC A01M 23/38; A01M 2200/00

(57) ABSTRACT

A mousetrap is provided, wherein an end of the mousetrap is a mouse passage entrance, a circuit mounting board is arranged between a base and an upper cover, and a circuit board, a battery and an electrode plate that are configured to form a current loop are mounted on the circuit mounting board. The shape of the electrode plates are all n-shaped, the opening directions are opposite, and the electrode plates are arranged staggered.

### FIELD OF THE DISCLOSURE

The present disclosure relates to a mousetrap, which belongs to the technical field of mousetraps.

### BACKGROUND OF THE DISCLOSURE

Mice are a more destructive beast. When they live together with humans, they will steal food, destroy clothing and property, and cause the epidemic of severe infectious diseases such as plague, which is harmful to people's physical and mental health and normal life. There is a big threat. Traditionally, people have used traditional iron clamps and other mousetraps to kill mice. However, this kind of iron clip with strong bite force will cause safety hazards to children and pets. A little carelessness will hurt children or pets. The iron mousetrap will leave the smell of dead mice on it, causing other mice to increase the vigilance and escape from the trap. The shortcomings of the prior art include: no sloping baffle, easy access by human hands, poor safety, easy escape of mice, low hunting rate, inconvenient disassembly, and difficulty in cleaning. The mousetraps in the prior art can no longer meet people's requirements, and there is an urgent need for a new and efficient rodent trap to replace the traditional iron mousetraps in the prior art.

### SUMMARY OF THE DISCLOSURE

The primary purpose of the present disclosure is to provide a mousetrap, aiming at the problems of poor safety, easy escape of mice, and low killing rate in the prior art, and solving the shortcomings of the prior art.

The present disclosure adopts the following technical solutions to the embodiment.

A mousetrap is provided, comprising: a base and an upper cover that are detachable and movably connected, wherein an accommodating space is formed between the base and the upper cover, one end of the mousetrap is a mouse passage entrance, a circuit mounting board is arranged between the base and the upper cover, and a circuit board, a battery and an electrode plate that are configured to form a current loop are mounted on the circuit mounting board.

Further, the electrode plate comprises: a first electrode plate and a second electrode plate which are mounted on the circuit board, wherein the first electrode plate and the second electrode plate are both n-shaped and opening directions of the first electrode plate and the second electrode plate are opposite and arranged in a staggered manner.

Further, a first baffle and a second baffle are movably connected with side walls of the base, and the first baffle and the second baffle are parallel to each other and arranged obliquely in the mouse passage entrance.

Further, a baffle is provided at the mouse passage entrance and comprises a sheet-shaped first baffle and a sheet-shaped second baffle, wherein the first baffle and the second baffle are staggered at the mouse passage entrance to form a tortuous passage, an elastic metal needle is mounted on the second baffle, and a needle tip of the elastic metal needle faces an inside of the mousetrap.

Further, one end of the first baffle and one end the second baffle are provided with protruding movable mounting columns, respectively, and mounting grooves corresponding to the shape of the movable mounting column are provided on the base.

Further, the first electrode plate and the second electrode plate are detachably connected with the circuit board.

Further, the first electrode plate and the second electrode plate are movably connected with the circuit board through screws or buckles.

The beneficial technical effect of the present disclosure is that the electronic circuit parts are all detachable, which is convenient for cleaning the residues after killing the mice. The first baffle and the second baffle form a tortuous passage into the internal accommodating space of the mousetrap, so that the mice can enter while children cannot reach in and pets cannot enter, which improves the safety of the product. The electrode plates can be energized. When the mouse touches the first electrode plate and the second electrode plate at the same time, the current forms a loop to electrocute the mouse, so that the mouse is killed under the premise of trauma and no leakage of smell, which not only improves the efficiency of the mousetrap, but also prevents other mice from discovering abnormalities and avoids the failure of the mousetrap.

### BRIEF DESCRIPTION OF THE DRAWINGS

FIG. 1 is a perspective view of a mousetrap.

FIG. 2 is a top view of the mousetrap.

FIG. 3 is a side view of the mousetrap.

FIG. 4 is an exploded view of the mousetrap.

FIG. 5 is a perspective exploded view of the mousetrap.

FIG. 6 is a top view of the base of the mousetrap with the upper cover removed.

FIG. 7 is a perspective view of the base of the mousetrap with the upper cover removed.

FIG. 8 is a schematic diagram illustrating the impact force of the mousetrap after removing the base plate.

FIG. 9 is a side view of the base.

FIG. 10 is a schematic diagram of the structure of the electrode plate.

FIG. 11 is a schematic diagram of the structure of the baffle.

FIG. 12 is a plan view of the circuit mounting board.

FIG. 13 is a perspective view of a circuit mounting board.

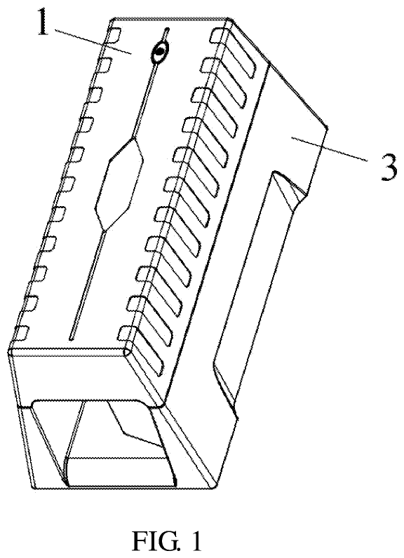

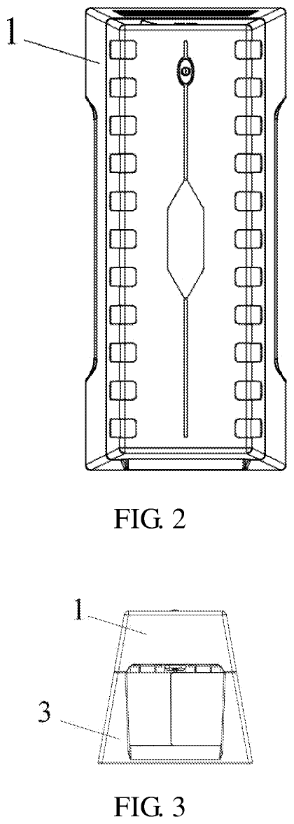

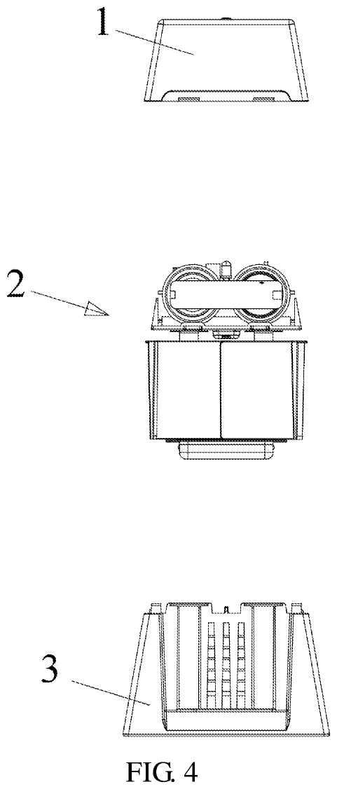

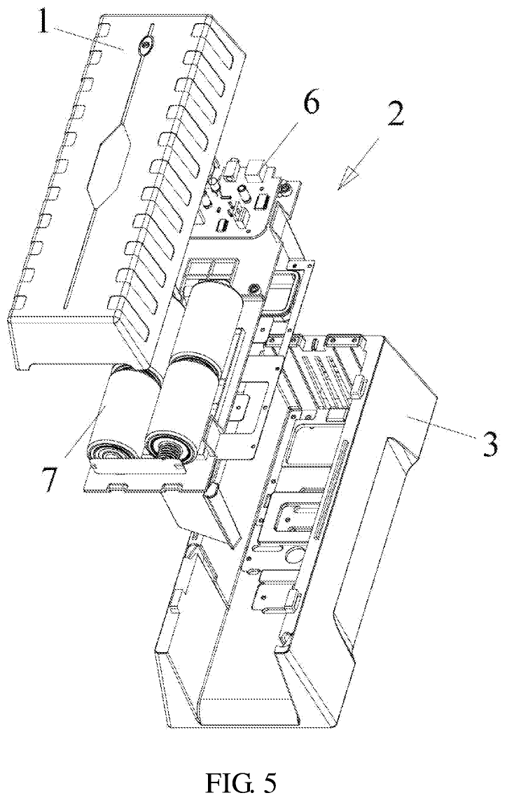

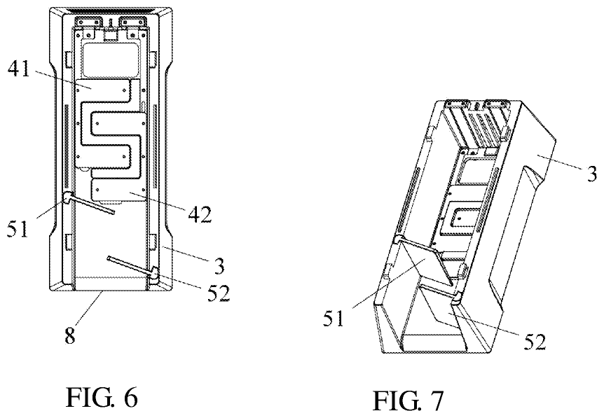

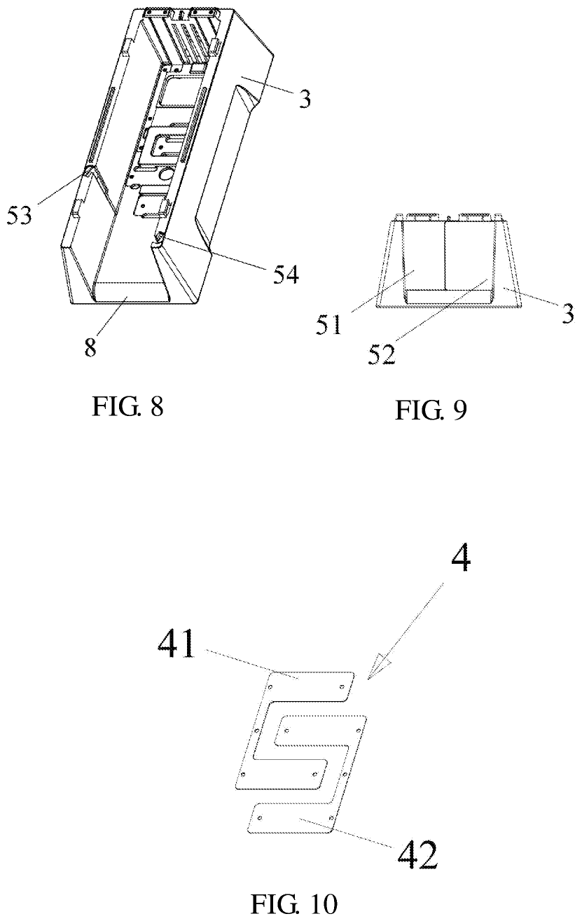

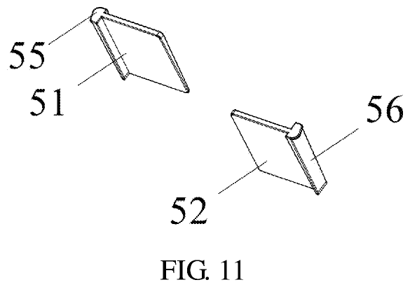

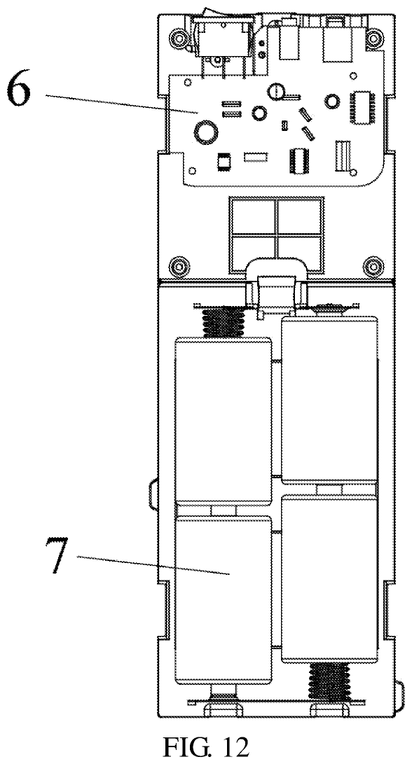

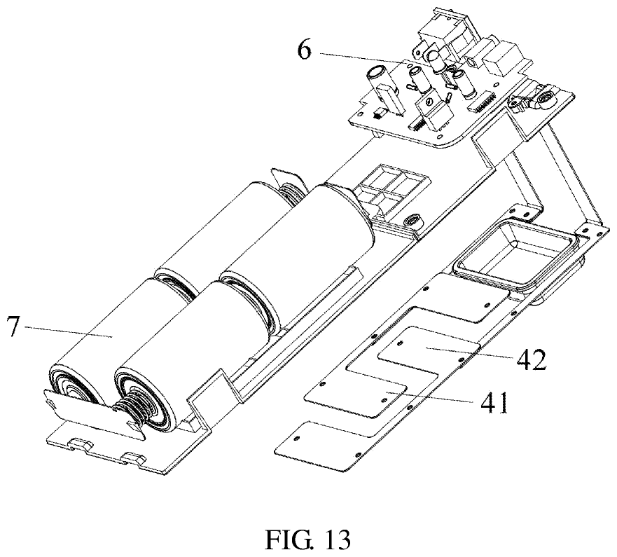

### DETAILED DESCRIPTION OF THE EXEMPLARY EMBODIMENTS

By means of the following description of the embodiments, it will be more helpful for the public to understand the present disclosure, but the specific embodiments given by the applicant cannot and should not be regarded as a limitation on the technical solution of the present disclosure, and any component or changes in the definition of technical features and/or changes in form but not in substance to the overall structure should be regarded as the scope of protection defined by the technical solution of the present disclosure.

A mousetrap includes a base 3 and an upper cover 1. The base 3 and the upper cover 1 are detachable and movably connected, and are connected by a high-strength metal bullet pin, which is convenient for disassembly and cleaning after rodent control. An accommodating space is formed between the upper cover 1 and the base 3, a circuit mounting board 2 is provided between the upper cover 1 and the base 3, and an electrode plate 4, a circuit board 6 and a battery 7 that can form a current loop are mounted on the circuit mounting board 2. Here “can form a current loop” means that although the electrode plate 4, the circuit board 6 and the battery 7 are in an open circuit state in the daily state, once a mouse enters the mousetrap and steps on the electrode plate 4, the mouse itself becomes a part of the conductor, and the circuit is instantly closed and the mouse suffers a strong electric shock. One end of the mousetrap is a mouse passage entrance 8. A baffle 5 is provided at the mouse passage entrance 8. The baffle 5 includes a sheet-shaped first baffle 51 and a second baffle 52. The mouse passage entrance 8 and the accommodating space are arranged alternately to form a tortuous passage. The first baffle 51 and the second baffle 52 are movably connected to the side wall of the base 3. One end of the first baffle 51 and one end of the second baffle 52 are provided with protruding movable mounting columns, respectively, and the base 3 is provided with movable mounting grooves of which the shape corresponds to the mounting columns. The mounting groove includes a first mounting groove 53 and a second mounting groove 54. The outline shape of the first mounting groove 53 and the second mounting groove 54 respectively matches the outline shape of the first movable mounting column 55 and the second movable mounting column 56. The first baffle 51 and the second baffle 52 are movably connected with the base 3 through the first movable mounting column 55 and the second movable mounting column 56. When mounting, the first movable mounting column 55 is clamped in the first mounting groove 53, and the second movable mounting column 56 is clamped in the second mounting groove 54. The steps for disassembly are just the opposite of the mounting, which is to remove the first baffle 51 and the second baffle 52 from the mounting grooves. In this embodiment, the first baffle 51 and the second baffle 52 are parallel to each other, and the first baffle 51 and the second baffle 52 are obliquely arranged in the mouse passage entrance 8. The purpose of this arrangement is to provide a tortuous passage for the mouse passage entrance 8, so that children's hands or pets' paws, legs, etc. cannot reach into the mouse passage entrance 8 and enter the accommodating space, but the mouse passage entrance 8 is still connected to the mousetrap, and the mouse can enter the mousetrap through the tortuous passage formed between the first baffle 51 and the second baffle 52, which can trap the mouse and prevent accidental damage to other creatures other than the mouse.

In this embodiment, the electrode plate 4 includes a first electrode plate 41 and a second electrode plate 42. The shapes of the first electrode plate 41 and the second electrode plate 42 are both n-shaped, that is, the shape of the first electrode 41 and the second electrode 42 is like the lowercase letter n, one end is an open end and the other end is a closed end. The combination of the electrode plate 4 is that the opening directions of the first electrode plate 41 and the second electrode plate 42 are opposed to each other and form a staggered structure. That is, the open end of the first electrode plate 41 and the open end of the second electrode plate 42 are opposite to each other, and they are interleaved with each other on the same horizontal plane, but there is an insulation distance between the first electrode plate 41 and the second electrode plate 42 and no electrical connection is formed, so it is impossible to form a circuit path and a current loop. When the mouse does not enter the mousetrap, the electrode plate 4, the circuit board 6 and the battery 7 do not have a current loop, and the entire circuit is not conductive. The first electrode plate 41 and the second electrode plate 42 are just in a state where current can be conducted at any time. When the mouse enters the mousetrap and touches the first electrode plate 41 and the second electrode plate 42 at the same time, the circuit is turned on and the current forms a loop. The mouse then gets electrocuted and died, at least severely injured and unable to move. In order to facilitate disassembly and cleaning, the connection between the first electrode plate 41 and the second electrode plate 42 and the circuit board 6 is a movable connection, and the specific movable connection is through a screw or a buckle. Those skilled in the art can arbitrarily choose specific activity connection methods that are beneficial to production and manufacturing according to actual conditions. The size of the voltage can be set by those skilled in the art according to actual needs. For example, a control circuit with a main control module can be used to set the circuit board. The circuit board also includes an indicator light and buzzer connected to the main control module, a power management module, a battery and a transformer module connected to the power management module, and a safety switch and a sound selection switch connected to the main control module. The controller uses two electrode outputs. When the electrode is in standby, the induction input is used as the induction trigger signal input. When a harmful animal is sensed, the two electrodes are converted into a high-voltage output of a specific waveform through the electrode plate to shock the entering harmful animal. After an electric shock, there are indicator lights and sound prompts, and the sound prompts can be turned on and off by the sound selection switch to adapt to different scenarios. AC or DC power supply can be used, AC220V adapter or battery can be used alone, or both can be used at the same time, and the battery can be charged by adding a charging control circuit module when using 220V mains electricity to prevent the failure of the deratization function due to accidental power failure. There are enough examples in the prior art that can embody high-voltage and high-current circuits, which will not be repeated here.

On the basis of the above embodiment, a further improvement can be made. Irregularly arranged elastic metal needles are installed on the first baffle 51 and the second baffle 52, and the needle tip of the elastic metal needle faces the inside of the mousetrap. When mice of different sizes enter the mousetrap through the first baffle 51 and the second baffle 52, the direction of the elastic metal needle prevents the mouse from turning back or going back, and can only move forward in the direction of the needle tip no matter what motive the mouse wants to go back the same way, and the elastic metal needle will become an obstacle for the mouse to escape, and it will sting the mouse so that the mouse cannot go back. The elastic metal needle can be any metal needle in the prior art, such as embroidery needles, etc., which are installed on the first baffle 51 and the second baffle 52 by welding, so that the tortuous passage from the mouse passage entrance 8 to the inside of the mousetrap becomes a one-way passage with no return to prevent the mouse from accidentally escaping.

Of course, the present disclosure can also have many other embodiments. Without departing from the spirit and essence of the present disclosure, those skilled in the art can make various corresponding changes and modifications according to the present disclosure, but these corresponding changes and deformations should belong to the protection scope of the appended claims of the present disclosure.

What is claimed is:

1. A mousetrap, comprising: a base and an upper cover that are detachable and movably connected, wherein an accommodating space is formed between the base and the upper cover, one end of the mousetrap is a mouse passage entrance, a circuit mounting board is arranged between the base and the upper cover, and a circuit board, a battery and an electrode plate that are configured to form a current loop are mounted on the circuit mounting board.

2. The mousetrap according to claim 1, wherein the electrode plate comprises: a first electrode plate and a second electrode plate which are mounted on the circuit board, wherein the first electrode plate and the second electrode plate are both n-shaped and opening directions of the first electrode plate and the second electrode plate are opposite and arranged in a staggered manner.

3. The mousetrap according to claim 2, wherein a first baffle and a second baffle are movably connected with side walls of the base, and the first baffle and the second baffle are parallel to each other and arranged obliquely in the mouse passage entrance.

4. The mousetrap according to claim 1, wherein a baffle is provided at the mouse passage entrance and comprises a sheet-shaped first baffle and a sheet-shaped second baffle, wherein the first baffle and the second baffle are staggered at the mouse passage entrance to form a tortuous passage, an elastic metal needle is mounted on the second baffle, and a needle tip of the elastic metal needle faces an inside of the mousetrap.

5. The mousetrap according to claim 1, wherein one end of the first baffle and one end of the second baffle are provided with protruding movable mounting columns, respectively, and mounting grooves corresponding to the shape of the movable mounting columns are provided on the base.

6. The mousetrap according to claim 1, wherein the first electrode plate and the second electrode plate are detachably connected with the circuit board.

7. The mousetrap according to claim 6, wherein the first electrode plate and the second electrode plate are movably connected with the circuit board through screws or buckles.
